(19) United States
(12) Patent Application Publication
(10) Pub. No.: US 2022/0187950 A1
(43) Pub. Date: Jun. 16, 2022

(54) DISPLAY MODULE

(71) Applicant: WUHAN CHINA STAR OPTOELECTRONICS SEMICONDUCTOR DISPLAY TECHNOLOGY CO., LTD., Wuhan, Hubei (CN)

(72) Inventors: Tengfei GE, Wuhan, Hubei (CN); Qibing DAI, Wuhan, Hubei (CN); Wenqi LI, Wuhan, Hubei (CN)

(21) Appl. No.: 17/054,696

(22) PCT Filed: Jun. 30, 2020
(86) PCT No.: PCT/CN2020/099357

§ 371 Date: Nov. 11, 2020

(30) Foreign Application Priority Data
Jun. 16, 2020 (CN) 2020 10545615.8

(51) Int. Cl. G06F 3/044; G06F 3/041; G06V 40/13

(52) U.S. Cl. CPC G06F 3/0446; G06V 40/1306; G06F 3/0416; G06F 3/0412

(57) ABSTRACT

A display module is provided. The display module includes a first touch electrode, second touch electrode, and a shorting unit. A fingerprint structure layer includes first fingerprint electrodes and second fingerprint electrodes. The shorting unit includes at least a first shorting circuit and at least a second shorting circuit. The first shorting circuit shorts at least two of the first fingerprint electrodes to form the first touch electrode. The second shorting circuit shorts at least two fingerprint electrodes to form the second touch electrode.

### FIELD

The present disclosure relates to display technologies, and more particularly, to a display module.

### BACKGROUND

With development of display technologies, display devices such as mobile phones are gradually developing towards a whole screen display with a high screen-to-body ratio. As a screen-to-body ratio of the mobile phone continues to increase, fingerprint recognition technologies have also been continuously developed. In order to increase the screen-to-body ratio, the existing fingerprint recognition module is generally positioned under a display screen, so that a display region where the fingerprint recognition module is located is a touch dead zone, and a touch function of this area cannot be realized.

### SUMMARY

In view of the above, the present disclosure provides a display module to resolve issues of touch dead zone with no touch function in the display region where the fingerprint module is located.

In order to achieve above-mentioned object of the present disclosure, one embodiment of the disclosure provides a display module, including a touch display region, wherein the touch display region is provided with a touch structure layer, and the touch structure layer includes a plurality of first touch electrodes and a plurality of second touch electrodes, and wherein the display module further includes:

a fingerprint structure layer integrated with the touch structure layer and including a plurality of first fingerprint electrodes and a plurality of second fingerprint electrodes, wherein the first fingerprint electrodes are driving electrodes and the second fingerprint electrodes are sensing electrodes;

a shorting unit including at least a first shorting circuit and at least a second shorting circuit, wherein the first shorting circuit is configured to short at least two of the first fingerprint electrodes to form one of the first touch electrodes, and the second shorting circuit is configured to short at least two fingerprint electrodes to form one of the second touch electrodes; and

a touch control chip including at least a first touch signal end and at least a second touch signal end.

In one embodiment of the display module of the disclosure, the fingerprint structure layer includes a plurality of first electrode traces, and each of the first electrode traces is electrically connected to one of the first fingerprint electrodes; and

the first shorting circuit includes at least a first control signal line and a plurality of first switches, each of the first switches includes a gate, a source and a drain, the gate of each of the first switches is electrically connected to the first control signal line, and the source and the drain of each of the first switches are electrically connected to one of the first electrode traces respectively.

In one embodiment of the display module of the disclosure, the fingerprint structure layer includes a plurality of second electrode traces, and each of the second electrode traces is electrically connected to one of the second fingerprint electrodes; and

the second shorting circuit includes at least a second control signal line and a plurality of second switches, each of the second switches includes a gate, a source and a drain, the gate of each of the second switches is electrically connected to the second control signal line, and the source and the drain of each of the second switches are electrically connected to one of the second electrode traces respectively.

In one embodiment of the display module of the disclosure, the shorting unit includes a signal control module, an output end of the signal control module is electrically connected to the first control signal line, and the first control signal line is electrically connected to the second control signal line.

In one embodiment of the display module of the disclosure, the shorting unit includes two signal control modules, a quantity of the first control signal line is one, and a quantity of the second control signal line is one; and

an output end of one of the signal control modules is electrically connected to the first control signal line, and an output end of another one of the signal control modules is electrically connected to the second control signal line.

In one embodiment of the display module of the disclosure, the first switches are P type transistors or N type transistors, and the second switches are P type transistors or N type transistors.

In one embodiment of the display module of the disclosure, the touch structure layer includes at least a first touch signal trace and at least a second touch signal trace, the first touch signal trace is electrically connected to one of the touch electrodes, and the second touch signal trace is electrically connected to one of the second touch electrodes; and

the first touch signal end is electrically connected to an end of the first touch signal trace away from the first shorting circuit, and the second touch signal end is electrically connected to an end of the second touch signal trace away from the second shorting circuit.

In one embodiment of the display module of the disclosure, the first touch signal end is an output end of a touch driving signal, and the second touch signal end is a receiving end of a touch sensing signal.

In one embodiment of the disclosure, the display module further including a fingerprint control chip, wherein the fingerprint control chip includes a plurality of first fingerprint signal ends and a plurality of second fingerprint signal ends;

each of the first fingerprint signal ends is electrically connected to an end of one of the first electrode traces away from the first fingerprint electrodes, and each of the second fingerprint signal ends is electrically connected to an end of one of the second electrode traces away from the first fingerprint electrodes.

Another embodiment of the disclosure further provides a display module, including a touch display region, wherein the touch display region is provided with a touch structure layer, and the touch structure layer includes a plurality of first touch electrodes and a plurality of second touch electrodes, wherein the display module further includes:

a fingerprint structure layer integrated with the touch structure layer and including a plurality of first fingerprint electrodes and a plurality of second fingerprint electrodes; and

a shorting unit including at least a first shorting circuit and at least a second shorting circuit, wherein the first shorting circuit is configured to short at least two of the first fingerprint electrodes to form one of the first touch electrodes, and the second shorting circuit is configured to short at least two fingerprint electrodes to form one of the second touch electrodes.

In one embodiment of the display module of the disclosure, the fingerprint structure layer includes a plurality of first electrode traces, and each of the first electrode traces is electrically connected to one of the first fingerprint electrodes; and

the first shorting circuit includes at least a first control signal line and a plurality of first switches, each of the first switches includes a gate, a source and a drain, the gate of each of the first switches is electrically connected to the first control signal line, and the source and the drain of each of the first switches are electrically connected to one of the first electrode traces respectively.

In one embodiment of the display module of the disclosure, the fingerprint structure layer includes a plurality of second electrode traces, and each of the second electrode traces is electrically connected to one of the second fingerprint electrodes; and

the second shorting circuit includes at least a second control signal line and a plurality of second switches, each of the second switches includes a gate, a source and a drain, the gate of each of the second switches is electrically connected to the second control signal line, and the source and the drain of each of the second switches are electrically connected to one of the second electrode traces respectively.

In one embodiment of the display module of the disclosure, the shorting unit includes a signal control module, an output end of the signal control module is electrically connected to the first control signal line, and the first control signal line is electrically connected to the second control signal line.

In one embodiment of the display module of the disclosure, the shorting unit includes two signal control modules, a quantity of the first control signal line is one, and a quantity of the second control signal line is one; and

an output end of one of the signal control modules is electrically connected to the first control signal line, and an output end of another one of the signal control modules is electrically connected to the second control signal line.

In one embodiment of the display module of the disclosure, the first switches are P type transistors or N type transistors, and the second switches are P type transistors or N type transistors.

In one embodiment of the disclosure, the display module further including a touch control chip including at least a first touch signal end and at least a second touch signal end, wherein the touch structure layer includes at least a first touch signal trace and at least a second touch signal trace, the first touch signal trace is electrically connected to one of the touch electrodes, and the second touch signal trace is electrically connected to one of the second touch electrodes; and

the first touch signal end is electrically connected to an end of the first touch signal trace away from the first shorting circuit, and the second touch signal end is electrically connected to an end of the second touch signal trace away from the second shorting circuit.

In one embodiment of the display module of the disclosure, the first touch signal end is an output end of a touch driving signal, and the second touch signal end is a receiving end of a touch sensing signal.

In one embodiment of the disclosure, the display module further including a fingerprint control chip, wherein the fingerprint control chip includes a plurality of first fingerprint signal ends and a plurality of second fingerprint signal ends;

each of the first fingerprint signal ends is electrically connected to an end of one of the first electrode traces away from the first fingerprint electrodes, and each of the second fingerprint signal ends is electrically connected to an end of one of the second electrode traces away from the first fingerprint electrodes.

In one embodiment of the display module of the disclosure, the first fingerprint electrodes are driving electrodes and the second fingerprint electrodes are sensing electrodes.

In comparison with prior art, the display module provides the shorting unit to use the fingerprint electrodes of the fingerprint structure layer as a touch electrode. When the shorting unit is in a disconnecting state, the first fingerprint electrode and the second fingerprint electrode work cooperatively to realize a fingerprint identifying function. When the shorting unit is in a normal working state, the first touch electrode and the second touch electrode work cooperatively to realize a touch function. The disclosure realizes the touch function at the display region where the fingerprint module is located without affect the fingerprint function to solve the technical issue that the touch dead zone of the display panel has no touch function.

### BRIEF DESCRIPTION OF DRAWINGS

Detailed descriptions of the embodiments of the present application will make the technical solution and other beneficial effects of the present application clear in the following with reference to drawings

FIG. 1 is a schematic view of structure of a display module according to an embodiment of the present disclosure.

FIG. 2 is a schematic sectional view of a structure alone a line AA′ in the FIG. 1.

FIG. 3 is a schematic view of a structure of a fingerprint identification region of a display module according to an embodiment of the present disclosure.

FIG. 4 is a schematic view of a structure of a first embodiment of a shorting unit of a display module according to an embodiment of the present disclosure.

FIG. 5 is a schematic view of a structure of a second embodiment of a shorting unit of a display module according to an embodiment of the present disclosure.

FIG. 6 is a schematic view of a timing diagram of a shorting unit of a display module according to an embodiment of the present disclosure.

### DETAILED DESCRIPTION

The technical solutions in the embodiments of the present application will be described clearly and completely in conjunction with the drawings in the embodiments of the present application. Obviously, the described embodiments are only a part of the embodiments of the present application, but not all the embodiments. Based on the embodiments in the present application, all other embodiments obtained by those skilled in the art without making creative work fall within the protection scope of the present application.

In the description of this application, it should be understood that the terms “center”, “longitudinal”, “transverse”, “length”, “width”, “thickness”, “upper”, “lower”, “front”, “Back, “Left”, “Right”, “Vertical”, “Horizontal”, “Top”, “Bottom”, “Inner”, “Outer”, “Clockwise”, “Counterclockwise” etc. The positional relationship is based on the orientation or positional relationship shown in the drawings, and is only for the convenience of describing the application and simplifying the description, rather than indicating or implying that the device or element referred to must have a specific orientation, be constructed and operated in a specific orientation, Therefore, it cannot be understood as a limitation to this application. In addition, the terms “first” and “second” are used for description purposes only, and cannot be understood as indicating or implying relative importance or implicitly indicating the number of technical features indicated. Thus, features defined as “first” and “second” may explicitly or implicitly include one or more of the features. In the description of this application, the meaning of “plurality” is two or more, unless otherwise specifically limited.

In the description of this application, it should be noted that, unless otherwise clearly specified and limited, the terms “installation”, “connection”, and “connection” should be understood in a broad sense, for example, it can be fixed connection or detachable Connected, or integrally connected; may be mechanical, electrical, or may communicate with each other; may be directly connected, or may be indirectly connected through an intermediary, may be the connection between two elements or the interaction of two elements relationship. Those of ordinary skill in the art can understand the specific meanings of the above terms in this application according to specific situations. In this embodiment, the analog display screen touch unit is connected to the head tracking unit, and is used to obtain a movement path of the sensitive cursor in the display device.

In this application, unless otherwise clearly specified and defined, the first feature “above” or “below” the second feature may include the direct contact of the first and second features, or may include the first and second features Contact not directly but through another feature between them. Moreover, the first feature is “above”, “over” and “on” the second feature includes that the first feature is directly above and obliquely above the second feature, or simply means that the first feature is higher in level than the second feature. The first feature is “below”, “under” and “beneath” the second feature includes that the first feature is directly below and obliquely below the second feature, or simply means that the first feature is less horizontal than the second feature.

The following disclosure provides many different implementations or examples for implementing different structures of the present application. In order to simplify the disclosure of the present application, the components and settings of specific examples are described below. Of course, they are only examples, and the purpose is not to limit this application. In addition, the present application may repeat reference numerals and/or reference letters in different examples. Such repetition is for the purpose of simplicity and clarity, and does not itself indicate the relationship between the various embodiments and/or settings discussed. In addition, the present application provides examples of various specific processes and materials, but those of ordinary skill in the art may be aware of the application of other processes and/or the use of other materials.

It should be noted that P-type transistors and N-type transistors used in this application can be thin film transistors or other field effect transistors. Since a source and a drain of the transistor used here are symmetrical, the source and drain are Interchangeable. In the embodiments of the present application, in order to distinguish two poles of the transistor other than the gate, one of the poles is called the source and the other is called the drain. According to the shape in the figures, it is stipulated that the middle end of the transistor is the gate, the signal input end is the source, and the signal output end is the drain.

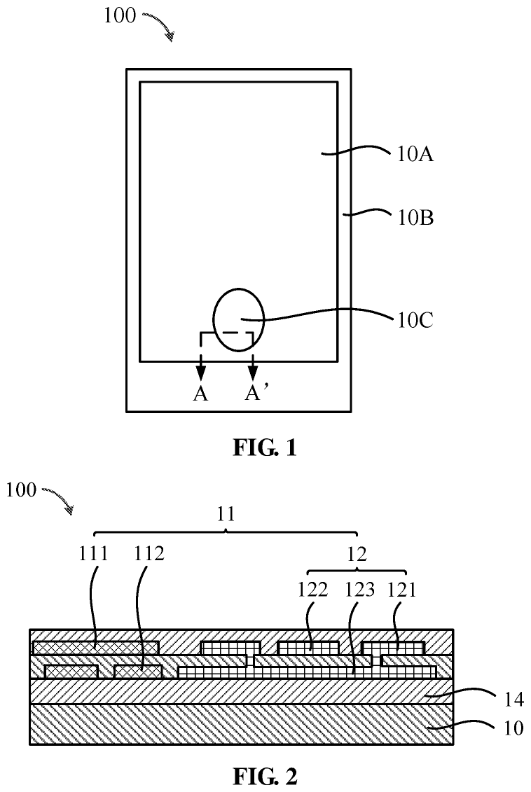

Referring to FIGS. 1 to 5, one embodiment of the disclosure provides a display module 100, including a touch display region 10A and a non-display region 10B. The touch display region 10A is provided with a touch structure layer 11. The touch structure layer 11 includes a plurality of first touch electrodes 111 and a plurality of second touch electrodes 112. The display module 100 further includes: a fingerprint structure layer 12, a shorting unit 13, a touch control chip 15, and a fingerprint control chip 16. The fingerprint structure layer 12 is integrated with the touch structure layer 11 and including a plurality of first fingerprint electrodes 121 and a plurality of second fingerprint electrodes 122. The shorting unit 13 including at least a first shorting circuit 131 and at least a second shorting circuit 132. The first shorting circuit 131 is configured to short at least two of the first fingerprint electrodes 121 to form one of the first touch electrodes 111, and the second shorting circuit 132 is configured to short at least two fingerprint electrodes 122 to form one of the second touch electrodes 112.

The display module in the embodiment provides the shorting unit 13 to use the fingerprint electrodes of the fingerprint structure layer 12 as a touch electrode. When the shorting unit 13 is in a disconnecting state, the first fingerprint electrode 121 and the second fingerprint electrode 122 work cooperatively to realize a fingerprint identifying function. When the shorting unit 13 is in a normal working state, the first touch electrode 111 and the second touch electrode 112 work cooperatively to realize a touch function. The disclosure realizes the touch function at the display region where the fingerprint module is located without affect the fingerprint function to solve the technical issue that the touch dead zone of the display panel has no touch function.

Understandably, the display module 100 in the embodiment further includes a display panel 10 and an insulating layer 14 disposed in sequence, as shown in FIG. 2. The provided insulating layer 14 can prevent from signal crosstalk between the electrode in the touch structure layer 11 and other circuit in the display panel 10. The display panel 10 can be a liquid crystal panel or an organic light-emitting diode display panel. Detail structures of the display panel 10 can refer to prior art, here will not describe it.

Further, the display module 100 in the embodiment further includes a backplate, an optical adhesive layer, and other film layers (not shown in the figures), and here will not describe it.

It should be noted that the touch structure layer 11 can be disposed on the display panel 10 or integral into the display panel 10. The embodiment takes the case that the touch structure layer 11 is disposed on the display panel 10 as an example, but the embodiment is not limited thereto. A detail structure of the touch structure layer 11 is describing for example, but not a limitation of the disclosure.

In one embodiment of the disclosure, the fingerprint structure layer 12 is integral with the touch structure layer 11. Detail of a method of integration of the fingerprint structure layer 12 can refer to prior art, and here will not describe it.

It should be noted that, the first fingerprint electrodes 121 and the second fingerprint electrodes 122 can disposed at a same layer or disposed at different layers. The embodiment takes the case that the first fingerprint electrodes 121 and the second fingerprint electrodes 122 can disposed at the same layer for example, but not a limitation of the disclosure.

In addition, the patterns of the first fingerprint electrode 121 and the second fingerprint electrode 122 in the disclosure can be rhombus, strip or square, etc. In this embodiment, only the first fingerprint electrode 121 and the second fingerprint electrode 122 are used. The patterns are all rhombuses as examples, but they are not limited to this.

In the embodiment of the disclosure, the first fingerprint electrode 121 is a driving electrode, and the second fingerprint electrode 122 is a sensing electrode. The fingerprint structure layer 12 also includes a plurality of bridges 123, and the bridges 123 are used to connect adjacent two of the first fingerprint electrodes 121. In addition, in some embodiments, the first fingerprint electrode 121 is a sensing electrode, and the second fingerprint electrode 122 is a driving electrode, and detail thereof will not be repeated here.

In the embodiment of the disclosure, a region where the fingerprint structure layer 12 is located is defined as a fingerprint region 10C, as shown in FIG. 1. The fingerprint region 10C can be arranged above, below or in other positions of the display panel 10. This embodiment only takes a case that the fingerprint region 10C is arranged below the display panel 10 as an example for description, but is not limited to this.

Further, in the embodiment of the disclosure, the shorting unit 13 is disposed on the portion of the non-display area 10B of the display panel 10, such as a flexible circuit board (not marked in the figure) or other peripheral circuits. In addition, a specific position of the shorting unit 13 can also be set according to the actual situation, which will not describe here.

It should be noted that the first shorting circuit 131 in the disclosure can short two or more of the first fingerprint electrodes 121 to form the first touch electrode 111. The second shorting circuit 132 short two or more second fingerprint electrodes 122 to form a second touch electrode 112. A specific quantity of the first shorting circuit 131 and the second shorting circuit 132 respectively shorting the first fingerprint electrodes 121 and the second fingerprint electrodes 122 can be set according to an actual situation, which is not limited in this application.

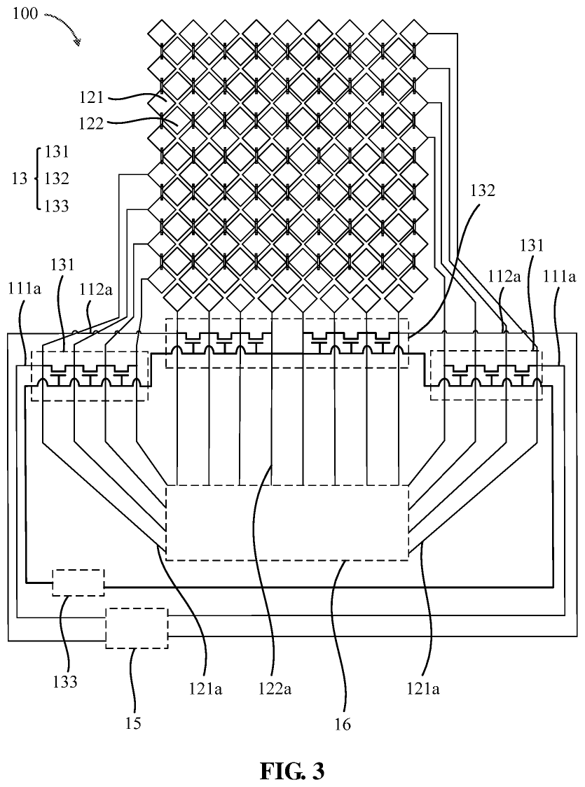

Please continue to refer to FIGS. 3 to 5. In the embodiment of the disclosure, the fingerprint structure layer 12 further includes a plurality of first electrode traces 121a and a plurality of second electrode traces 122a. The first electrode traces 121a are electrically connected to a first fingerprint electrodes 121 in a one-to-one correspondence. The first shorting circuit 131 includes at least one first control signal line 131a and a plurality of first switches 131b. Each of the first switches 131b includes a gate, a source, and a drain. The gate of each of the first switches 131b is electrically connected to a corresponding one of the first control signal line 131a. The source and drain of each of the first switches 131b are electrically connected to one of the first electrode traces 121a in a one-to-one correspondence.

The second electrode traces 122a are electrically connected to second fingerprint electrodes 122 in a one-to-one correspondence. The second shorting circuit 132 includes at least one second control signal line 132a and a plurality of second switches 132b. Each of the second switches 132b includes a gate, a source, and a drain. The gate of each of the second switches 132b is electrically connected to the corresponding second control signal line 132a. The source and drain of each of the second switches 132b are electrically connected to one of the second electrode traces 122a in a one-to-one correspondence.

Optionally, the first switch is a P-type transistor or an N-type transistor. The second switch is a P-type transistor or an N-type transistor.

In the embodiment of the disclosure, the first switch 131b and the second switch 132b are both P-type transistors.

Further, in the embodiment of the disclosure, a quantity of the first shorting circuit 131 is two. In some embodiments, the quantity of the first shorting circuit 131 is one or more. The quantity of the first shorting circuit 131 can be selected according to an arrangement of the first electrode traces 121a, which is not limited in this application.

It should be noted that a quantity of the second shorting circuit 132 in this application can be one, two or more. This embodiment only takes one second shorting circuit 132 as an example for description, but it is not limited to this.

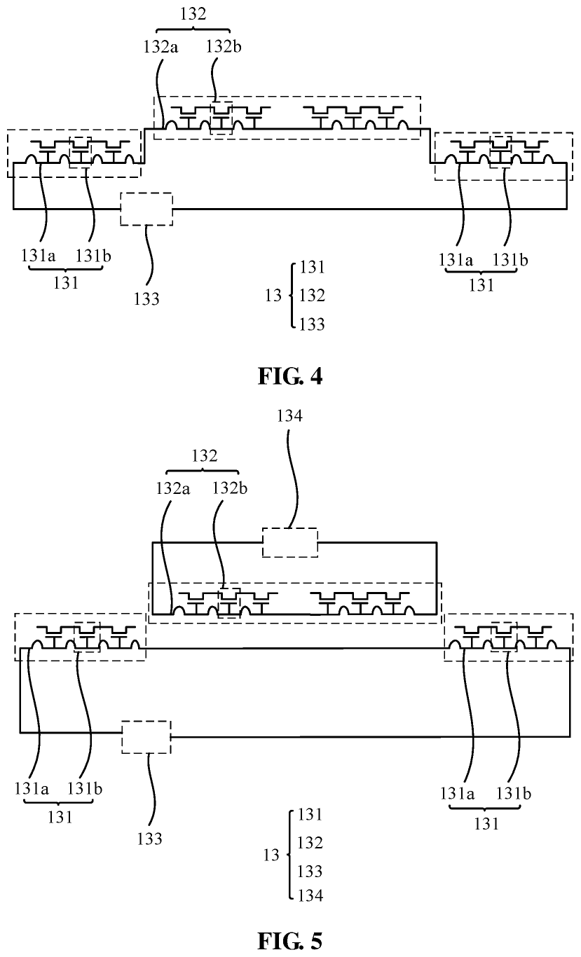

Please continue to refer to FIG. 4, FIG. 4 is a schematic view of a structure of a first embodiment of a shorting unit of a display module according to an embodiment of the present disclosure. In the embodiment of the disclosure, the shorting unit 13 includes a signal control module 133. An output end of the signal control module 133 is electrically connected to the first control signal line 131a. The first control signal line 131a is electrically connected to the second control signal line 132a.

It can be understood that the signal control module 133 is used to input control signals to the gates of the first switch 131b and the second switch 132b through the first control signal line 131a and the second control signal line 132a, respectively, to control turning on or off of the first switching 131b and the second switching 132b. The above arrangement is beneficial to simplifying the circuit structure and saving process cost by using a signal control module 133 to input control signals to the shorting unit 13.

In the embodiment of the disclosure, the shorting unit 13 includes two signal control modules, as shown in FIG. 5. FIG. 5 is a schematic view of a structure of a second embodiment of a shorting unit of a display module according to an embodiment of the present disclosure. In detail, the quantity of the first control signal line 131a and the quantity of the second control signal line 132a are both one. An output end of a signal control module 133 is electrically connected to the first control signal line 131a. An output end of another signal control module 134 is electrically connected to the second control signal line 132a.

It should be noted that in the shorting unit 13 shown in FIG. 5, one signal control module 133 is defined as the first signal control module 133 and another signal control module 134 is defined as the second signal control module 134.

It can be understood that the first signal control module 133 is used to transmit a control signal to the gate of the first switch 131b through the first control signal line 131a, so as to control turning on and off of the first switch 131b. The second signal control module 134 is used to transmit a control signal to the gate of the second switch 132b through the second control signal line 132a, so as to control turning on and off of the second switch 132b.

The above configuration uses the first signal control module 133 and the second signal control module 134 to input control signals to the first shorting circuit 131 and the second shorting circuit 132, respectively, and the quantity of the first control signal line 131a and the quantity of the second control signal line 132a is both set to one, thereby helping to reduce the delay effect of the control signal and avoid from affecting the transmission of the control signal. In addition, sharing a control signal line between the first shorting circuit 131 and the second shorting circuit 132 can also improve the stability of the first shorting circuit 131 and the second shorting circuit 132, thereby ensuring work efficiency of the shorting unit 13.

It should be noted that in the embodiment of the disclosure, the signal control module is provided in the shorting unit 13. In some embodiments, the signal control module can also be integrated with the touch control chip 15 or the fingerprint control chip 16. This arrangement is beneficial to simplify the process and save the process cost.

Further, the touch control chip 15 includes at least one first touch signal end and at least one second touch signal end. The touch structure layer 11 further includes at least one first touch signal trace 111a and at least one second touch signal trace 112a. The first touch signal trace 111a is electrically connected to a first touch electrode 111 in a one-to-one correspondence. The second touch signal trace 112a is electrically connected to a second touch electrode 112 in a one-to-one correspondence. The first touch signal end is electrically connected to an end of the first touch signal trace 111a away from the first shorting circuit 131. The second touch signal end is electrically connected to an end of the second touch signal trace 112a away from the second shorting circuit 132.

In the embodiment of the present application, the first touch signal end is an output end of a touch driving signal. The second touch signal end is a receiving end of a touch sensing signal.

In some embodiments, the first touch signal end is the receiving end of the touch sensing signal. The second touch signal end is the output end of the touch driving signal.

Further, the fingerprint control chip 16 includes a plurality of first fingerprint signal ends and a plurality of second fingerprint signal ends. The first fingerprint signal end is electrically connected to an end of the first electrode trace 121a away from the first fingerprint electrode 121 in a one-to-one correspondence. The second fingerprint signal end is electrically connected to an end of the second electrode trace 122a away from the second fingerprint electrode 122 in a one-to-one correspondence.

In the embodiment of the disclosure, the first fingerprint signal end is an output end of a fingerprint driving signal, and the second fingerprint signal end is a receiving end of a fingerprint sensing signal.

It should be noted that the touch control chip 15 and the fingerprint control chip 16 in the disclosure can be arranged on a flexible circuit board (not marked in the figure), and details will not be described here.

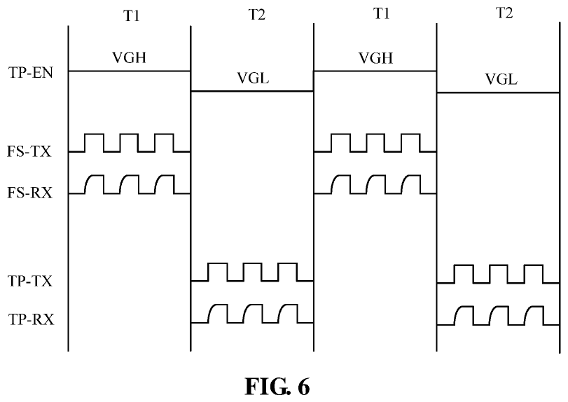

Please refer to FIG. 3, FIG. 4, and FIG. 6 together, where FIG. 6 is a signal timing diagram of the shorting unit in the display module provided by an embodiment of the application.

It should be noted that the signal timing diagram of the shorting unit 13 in this embodiment only takes the shorting unit 13 in FIG. 4 as an example for description, and the signal timing diagram in this embodiment can also be obtained according to other structures of the shorting unit 13.

In addition, in the embodiment of the disclosure, TP-EN is a control signal. The signal control module 133 transmits the control signal TP-EN to the gates of the first switch 131b and the second switch 132b through the first control signal line 131a and the second control signal line 132a, respectively, so as to control turning on and off of the first switch 131b and the second switch 132b and then to control a working state of the shorting unit 13. Wherein, when the control signal TP-EN is a high-level signal VGH, the first switch 131b and the second switch 132b are turned off, and the shorting unit 13 is in a disconnecting state. When the control signal TP-EN is a low-level signal VGL, at this moment, the first switch 131b and the second switch 132b are turned on, and the shorting unit 13 is in a normal working state.

In the T1 stage, the fingerprint function is turned on and the touch function is turned off.

In detail, the first signal control module 133 transmits the high-level signal VGH to the gates of the first switch 131b and the second switch 132b through the first control signal line 131a, and the first switch 131b and the second switch 132b are turned off. The shorting unit 13 is in a disconnecting state.

The fingerprint control chip 16 transmits the fingerprint drive signal FS-TX to the first fingerprint electrode 121 through the first fingerprint signal end, and then the second fingerprint electrode 122 receives the fingerprint sensing signal FS-RX through the second fingerprint signal tend. At this moment, a capacitor formed by the first fingerprint electrode 121 and the second fingerprint electrode 122 is charged, so that the fingerprint function is realized through the cooperative work of the first fingerprint electrode 121 and the second fingerprint electrode 122.

In the T2 stage, the fingerprint function is turned off and the touch function is turned on.

In detail, the fingerprint control chip 16 suspends pins of the first electrode trace 121a and the second electrode trace 122a, and the fingerprint function is turned off. Next, the first signal control module 133 transmits a low-level signal VGL to the gates of the first switch 131b and the second switch 132b through the first control signal line 131a, and the first switch 131b and the second switch 132b are turned on and the shorting unit 13 is in a normal working state.

At this moment, the first electrode trace 121a is shorted to form the first touch electrode 111, and the second electrode trace 122a is shorted to form the second touch electrode 112. In detail, the first electrode trace 121a in each of the first shorting circuit 131 is shorted to form a first touch electrode 111 (driving electrode), and the second electrode trace 122a in each of the second shorting circuit 132 is shorted to form a second touch electrode 112 (sensing electrode). Thus, the touch function is enabled, the touch control chip 15 transmits the touch driving signal TP-TX to the first touch electrode 111 through the first touch signal end, and then the second touch electrode 112 receives the touch sensing signal TP-RX through the second touch signal end. At this moment, a capacitor formed by the first touch electrode 111 and the second touch electrode 112 is charged, so that the first touch electrode 111 and the second touch electrode 112 work cooperatively to realize the touch function.

In comparison with prior art, the display module provides the shorting unit to use the fingerprint electrodes of the fingerprint structure layer as a touch electrode. When the shorting unit is in a disconnecting state, the first fingerprint electrode and the second fingerprint electrode work cooperatively to realize a fingerprint identifying function. When the shorting unit is in a normal working state, the first touch electrode and the second touch electrode work cooperatively to realize a touch function. The disclosure realizes the touch function at the display region where the fingerprint module is located without affect the fingerprint function to solve the technical issue that the touch dead zone of the display panel has no touch function.

The present disclosure has been described by the above embodiments, but the embodiments are merely examples for implementing the present disclosure. It must be noted that the embodiments do not limit the scope of the invention. In contrast, modifications and equivalent arrangements are intended to be included within the scope of the invention.

What is claimed is:

1. A display module, comprising a touch display region, wherein the touch display region is provided with a touch structure layer, and the touch structure layer comprises a plurality of first touch electrodes and a plurality of second touch electrodes, wherein the display module further comprises:
a fingerprint structure layer integrated with the touch structure layer and comprising a plurality of first fingerprint electrodes and a plurality of second fingerprint electrodes, wherein the first fingerprint electrodes are driving electrodes and the second fingerprint electrodes are sensing electrodes;
a shorting unit comprising at least a first shorting circuit and at least a second shorting circuit, wherein the first shorting circuit is configured to short at least two of the first fingerprint electrodes to form one of the first touch electrodes, and the second shorting circuit is configured to short at least two fingerprint electrodes to form one of the second touch electrodes; and
a touch control chip comprising at least a first touch signal end and at least a second touch signal end.

2. The display module according to claim 1, wherein the fingerprint structure layer comprises a plurality of first electrode traces, and each of the first electrode traces is electrically connected to one of the first fingerprint electrodes; and
the first shorting circuit comprises at least a first control signal line and a plurality of first switches, each of the first switches comprises a gate, a source and a drain, the gate of each of the first switches is electrically connected to the first control signal line, and the source and the drain of each of the first switches are electrically connected to one of the first electrode traces respectively.

3. The display module according to claim 2, wherein the fingerprint structure layer comprises a plurality of second electrode traces, and each of the second electrode traces is electrically connected to one of the second fingerprint electrodes; and
the second shorting circuit comprises at least a second control signal line and a plurality of second switches, each of the second switches comprises a gate, a source and a drain, the gate of each of the second switches is electrically connected to the second control signal line, and the source and the drain of each of the second switches are electrically connected to one of the second electrode traces respectively.

4. The display module according to claim 3, wherein the shorting unit comprises a signal control module, an output end of the signal control module is electrically connected to the first control signal line, and the first control signal line is electrically connected to the second control signal line.

5. The display module according to claim 3, wherein the shorting unit comprises two signal control modules, a quantity of the first control signal line is one, and a quantity of the second control signal line is one; and
an output end of one of the signal control modules is electrically connected to the first control signal line, and an output end of another one of the signal control modules is electrically connected to the second control signal line.

6. The display module according to claim 3, wherein the first switches are P type transistors or N type transistors, and the second switches are P type transistors or N type transistors.

7. The display module according to claim 1, wherein the touch structure layer comprises at least a first touch signal trace and at least a second touch signal trace, the first touch signal trace is electrically connected to one of the touch electrodes, and the second touch signal trace is electrically connected to one of the second touch electrodes; and
the first touch signal end is electrically connected to an end of the first touch signal trace away from the first shorting circuit, and the second touch signal end is electrically connected to an end of the second touch signal trace away from the second shorting circuit.

8. The display module according to claim 7, wherein the first touch signal end is an output end of a touch driving signal, and the second touch signal end is a receiving end of a touch sensing signal.

9. The display module according to claim 2, further comprising a fingerprint control chip, wherein the fingerprint control chip comprises a plurality of first fingerprint signal ends and a plurality of second fingerprint signal ends;
each of the first fingerprint signal ends is electrically connected to an end of one of the first electrode traces away from the first fingerprint electrodes, and each of the second fingerprint signal ends is electrically connected to an end of one of the second electrode traces away from the first fingerprint electrodes.

10. A display module, comprising a touch display region, wherein the touch display region is provided with a touch structure layer, and the touch structure layer comprises a plurality of first touch electrodes and a plurality of second touch electrodes, wherein the display module further comprises:
a fingerprint structure layer integrated with the touch structure layer and comprising a plurality of first fingerprint electrodes and a plurality of second fingerprint electrodes; and
a shorting unit comprising at least a first shorting circuit and at least a second shorting circuit, wherein the first shorting circuit is configured to short at least two of the first fingerprint electrodes to form one of the first touch electrodes, and the second shorting circuit is configured to short at least two fingerprint electrodes to form one of the second touch electrodes.

11. The display module according to claim 10, wherein the fingerprint structure layer comprises a plurality of first electrode traces, and each of the first electrode traces is electrically connected to one of the first fingerprint electrodes; and
the first shorting circuit comprises at least a first control signal line and a plurality of first switches, each of the first switches comprises a gate, a source and a drain, the gate of each of the first switches is electrically connected to the first control signal line, and the source and the drain of each of the first switches are electrically connected to one of the first electrode traces respectively.

12. The display module according to claim 11, wherein the fingerprint structure layer comprises a plurality of second electrode traces, and each of the second electrode traces is electrically connected to one of the second fingerprint electrodes; and
the second shorting circuit comprises at least a second control signal line and a plurality of second switches, each of the second switches comprises a gate, a source and a drain, the gate of each of the second switches is electrically connected to the second control signal line, and the source and the drain of each of the second switches are electrically connected to one of the second electrode traces respectively.

13. The display module according to claim 12, wherein the shorting unit comprises a signal control module, an output end of the signal control module is electrically connected to the first control signal line, and the first control signal line is electrically connected to the second control signal line.

14. The display module according to claim 12, wherein the shorting unit comprises two signal control modules, a quantity of the first control signal line is one, and a quantity of the second control signal line is one; and
an output end of one of the signal control modules is electrically connected to the first control signal line, and an output end of another one of the signal control modules is electrically connected to the second control signal line.

15. The display module according to claim 12, wherein the first switches are P type transistors or N type transistors, and the second switches are P type transistors or N type transistors.

16. The display module according to claim 10, further comprising a touch control chip comprising at least a first touch signal end and at least a second touch signal end, wherein the touch structure layer comprises at least a first touch signal trace and at least a second touch signal trace, the first touch signal trace is electrically connected to one of the touch electrodes, and the second touch signal trace is electrically connected to one of the second touch electrodes; and
the first touch signal end is electrically connected to an end of the first touch signal trace away from the first shorting circuit, and the second touch signal end is electrically connected to an end of the second touch signal trace away from the second shorting circuit.

17. The display module according to claim 16, wherein the first touch signal end is an output end of a touch driving signal, and the second touch signal end is a receiving end of a touch sensing signal.

18. The display module according to claim 11, further comprising a fingerprint control chip, wherein the fingerprint control chip comprises a plurality of first fingerprint signal ends and a plurality of second fingerprint signal ends;
each of the first fingerprint signal ends is electrically connected to an end of one of the first electrode traces away from the first fingerprint electrodes, and each of the second fingerprint signal ends is electrically connected to an end of one of the second electrode traces away from the first fingerprint electrodes.

19. The display module according to claim 10, wherein the first fingerprint electrodes are driving electrodes and the second fingerprint electrodes are sensing electrodes.
